(19) United States
(12) Patent Application Publication
(10) Pub. No.: US 2009/0000043 A1
(43) Pub. Date: Jan. 1, 2009

(54) Process for The Treatment of Fiber Materials

(76) Inventors: Wolfgang Schlenker, Aesch (CH); Mario Dubini, Niederdorf (CH)

Correspondence Address: JoAnn Villamizar;Ciba Corporation/Patent Department, 540 White Plains Road, P.O. Box 2005, Tarrytown, NY, 10591, US

(21) Appl. No.: 12/087,622

(22) PCT Filed: Jan. 8, 2007
(86) PCT No.: PCT/EP2007/050127

§ 371 Date: Jul. 10, 2008

(30) Foreign Application Priority Data
Jan. 18, 2006 (EP) 06100513.8
Jan. 31, 2006 (EP) 06101102.9

(51) Int. Cl. C11D 3/40; D06P 3/72; D06P 3/26; D06P 3/54; D06P 3/14

(52) U.S. Cl. 8/648; 510/515; 510/292; 510/276

(57) ABSTRACT

The present invention relates to a process for improving the whiteness of fibre materials selected from the group consisting of polyester, polyamide, polyacrylonitrile, wool and silk, wherein the fibre materials are treated with at least one disperse dye in a laundry process.

The present invention is directed to a process for improving the whiteness of fibre materials selected from the group consisting of polyester, polyamide, polyacrylonitrile, wool and silk, wherein the fibre materials are treated with at least one disperse dye in a laundry process.

Often, such fiber materials do not show the desired grade of whiteness. It was found that in many cases the whiteness cannot be increased to the desired grade of whiteness by simply applying brighteners, for example by laundering with whitener containing detergents. In view of the above there is still a need to improve the whiteness of such fiber materials.

It has now surprisingly been found that the treatment with disperse dyes in laundry processes allows to improve the whiteness of such fiber materials.

In addition, it is known that fibre materials show in the course of time a decrease of the whiteness grade. Surprisingly, the present invention allows to improve the whiteness of such fiber materials again.

Thus, the present invention primarily pertains to a process for improving the whiteness of fibre materials selected from the group consisting of polyester, polyamide, polyacrylonitrile, wool and silk, comprising treating the fibre materials with at least one disperse dye in a laundry process.

Suitable disperse dyes for the process of the invention are those described under “Disperse Dyes” in the Colour Index, 3rd edition (3rd Revision 1987 including additions and amendments up to No. 85). Examples are carboxyl- and/or sulfo-free nitro, amino, amino ketone, ketone imine, methine, polymethine, diphenylamine, quinoline, benzimidazole, xanthene, oxazine or coumarin dyes, and especially anthraquinone dyes and azo dyes, such as monoazo or disazo dyes. Preference is given to blue, violet, red or pink disperse dyes.

Preferred is the use of at least one disperse dye of the following formulae:

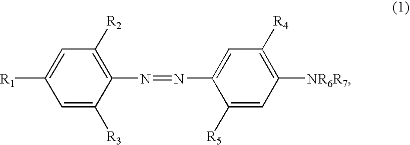

in which
R₁ is halogen, nitro or cyano,
R₂ is hydrogen, halogen, nitro or cyano,
R₃ is hydrogen, halogen or cyano,
R₄ is hydrogen, halogen, C₁-C₄alkyl or C₁-C₄alkoxy,
R₅ is hydrogen, halogen or C₂-C₄alkanoylamino, and
R₆ and R₇ independently of one another are hydrogen, allyl, C₁-C₄alkyl which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy,

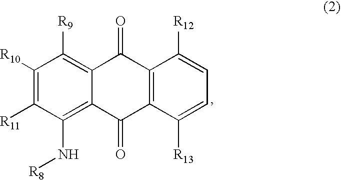

in which
R₈ is hydrogen, C₁-C₄alkyl, phenyl or phenylsulfonyl, the benzene ring in phenyl and phenylsulfonyl being unsubstituted or substituted by C₁-C₄alkyl, sulfo or C₁-C₄alkyl-sulfonyloxy,
R₉ is hydroxy, amino, N-mono- or N,N-di-C₁-C₄alkylamino, phenylamino, the benzene ring in phenyl being unsubstituted or substituted by halogen, C₁-C₄alkyl, C₁-C₄alkoxy, C₂-C₄alkanoylamino, or C₁-C₈alkylaminosulfonyl which can be interrupted in the alkyl chain by —O—,
R₁₀ is hydrogen, C₁-C₄alkoxy or cyano,
R₁₁ is hydrogen, C₁-C₄alkoxy, phenoxy or the radical —O—C₆H₅—SO₂—NH—(CH₂)₃—O—C₂H₅,
R₁₂ is hydrogen, hydroxy or nitro, and
R₁₃ is hydrogen, hydroxy or nitro,

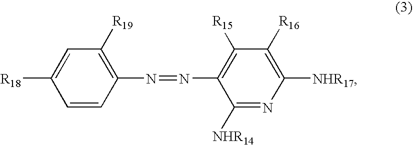

in which
R₁₄ is C₁-C₄alkyl which is unsubstituted or substituted by hydroxy,
R₁₅ is C₁-C₄alkyl,
R₁₆ is cyano,
R₁₇ is the radical of the formula —(CH₂)₃—O—(CH₂)₂—O—C₆H₅,
R₁₈ is halogen, nitro or cyano, and
R₁₉ is hydrogen, halogen, nitro or cyano,

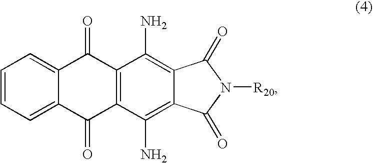

in which
R₂₀ is C₁-C₄alkyl, which is unsubstituted or substituted by hydroxy, C₁-C₄alkoxy, C₁-C₄-alkoxy-C₁-C₄alkoxy, C₂-C₄alkanoyloxy or C₁-C₄alkoxycarbonyl,

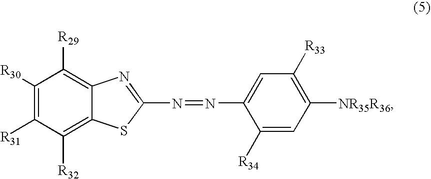

in which
R₂₉, R₃₀, R₃₁ and R₃₂ independently of one another are hydrogen or halogen,
R₃₃ is hydrogen, halogen, C₁-C₄alkyl or C₁-C₄alkoxy,
R₃₄ is hydrogen, halogen or C₂-C₄alkanoylamino, and
R₃₅ and R₃₆ independently of one another are hydrogen, C₁-C₄alkyl, which is unsubstituted or substituted by hydroxy, cyano, acetoxy or phenoxy,

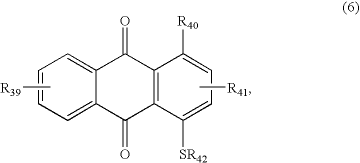

in which
R₃₉ is hydrogen or thiophenyl, which is unsubstituted or substituted in the phenyl by C₁-C₄-alkyl or C₁-C₄-alkoxy,
R₄₀ is hydrogen, hydroxy or amino,
R₄₁ is hydrogen, halogen, cyano or thiophenyl, which is unsubstituted or substituted in the phenyl by C₁-C₄alkyl or C₁-C₄-alkoxy, phenoxy or phenyl, and
R₄₂ is phenyl, which is unsubstituted or substituted by halogen, C₁-C₄alkyl or C₁-C₄-alkoxy,

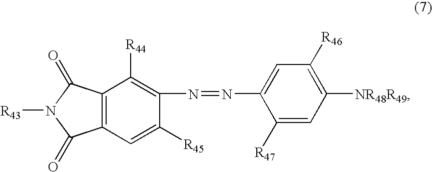

in which
R₄₃ is hydrogen or C₁-C₄alkyl,
R₄₄ and R₄₅ independently of one another are hydrogen, halogen, nitro or cyano,
R₄₆ is hydrogen, halogen, C₁-C₄alkyl or C₁-C₄alkoxy,
R₄₇ is hydrogen, halogen or C₂-C₄alkanoylamino, and
R₄₈ and R₄₉ independently of one another are hydrogen or C₁-C₄alkyl, which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy.

Preferred are disperse dyes of formulae (1), (2), (4) and (6), especially those of formulae (1) and (2).

As C₁-C₄alkyl radicals there come into consideration, for example, methyl, ethyl, n-propyl, isopropyl, n-butyl, sec-butyl, tert-butyl and isobutyl, preferably methyl and ethyl.

As C₁-C₄alkoxy radicals there come into consideration, for example, methoxy, ethoxy, n-propoxy, isopropoxy, n-butoxy, sec-butoxy, tert-butoxy and isobutoxy, preferably methoxy and ethoxy, and especially methoxy.

As halogen there come into consideration, for example, fluorine, chlorine, bromine and iodine, preferably chlorine and bromine, and especially chlorine.

As C₂-C₄alkanoylamino radicals there come into consideration, for example, acetylamino and propionylamino, especially acetylamino.

As C₁-C₄alkoxy-C₁-C₄alkoxy radicals there come into consideration, for example, methoxy-methoxy, methoxy-ethoxy, ethoxy-methoxy, ethoxy-ethoxy, ethoxy-n-propoxy, n-propoxy-methoxy, n-propoxy-ethoxy, ethoxy-n-butoxy and ethoxy-isopropoxy, preferably ethoxy-methoxy and ethoxy-ethoxy.

As N-mono- or N,N-di-C₁-C₄alkylamino radicals there come into consideration, for example, N-methylamino, N-ethylamino, N-propylamino, N-isopropylamino, N-butylamino, N-sec-butylamino, N-isobutylamino, N,N-dimethylamino and N,N-diethylamino, preferably N-isopropylamino.

As C₂-C₄alkanoyloxy radicals there come into consideration, for example, acetyloxy and propionyloxy, preferably acetyloxy.

As C₁-C₄alkoxycarbonyl radicals there come into consideration, for example, methoxycarbonyl, ethoxycarbonyl, n-propoxycarbonyl, isopropoxycarbonyl and n-butoxycarbonyl, preferably methoxycarbonyl and ethoxycarbonyl.

As C₁-C₄alkylsulfonyloxy radicals there come into consideration, for example, methylsulfonyloxy, ethylsulfonyloxy, n-propylsulfonyloxy, isopropylsulfonyloxy and n-butylsulfonyloxy, preferably methylsulfonyloxy and ethylsulfonyloxy.

The disperse dyes used in accordance with the present invention may be used as single compounds or as a mixture of two or more dyes.

The disperse dyes of formulae (1) to (7) are known or can be obtained analogously to known compounds, e.g. by customary diazotisation, coupling, addition and condensation reactions.

Suitable fibre materials are polyester, polyamide, polyacrylonitrile, wool and silk fiber materials as well as corresponding blended fibre materials. Preferred are polyester, polyamide and polyacrylonitrile, especially polyester and polyamide. Highly preferred is polyester.

In case of blends, the fibre materials preferably comprise at least 10% by weight, especially at least 20% by weight, of polyester, polyamide, polyacrylonitrile, wool or silk.

The fibre material may be blended with other synthetic or natural fibre materials. Examples of such other synthetic fibre materials are polyamide, polyacrylonitrile, polyacryl, polyisoprene and polyurethane. Examples of such natural fibre materials are cotton, viscose, flax, rayon, linen, wool, mohair, cashmere, angora and silk. As to the blends preference is given to polyester/cotton or polyester/polyamide blends.

In such blends it is preferred that the ratio by weight of polyester, polyamide, polyacrylonitrile, wool or silk to other synthetic or natural fibre material is 80:20 to 20:80, more preferably 70:30 to 30:70.

The said fibre material may be in any form, like usual clothes.

Preferred is an improvement of the whiteness grade by at least 3 whiteness grades according to Ganz, especially at least 5, and more preferably at least 10 whiteness grades, compared to the fiber material before the treatment.

In the general context of the present invention, the process covers all processes carried out in laundering (pre-soaking, washing, and after-treatment like rinsing).

According to one embodiment of the present invention the fibre materials are treated with at least one disperse dye together with a detergent in the washing step of a laundering process. In this process the detergent and the disperse dyes may be added separately; however, it is preferred that the disperse dyes are part of the detergent.

The process can be carried out in a washing machine as well as by hand. The usual washing temperature is between 5° C. and 95° C.

The washing or cleaning agents are usually formulated that the washing liquor has pH value of about 6.5-11, preferably 7.5-11 during the whole washing procedure.

The liquor ratio in the washing process is usually 1:2 to 1:40, preferably 1:4 to 1:15, more preferably 1:4 to 1:10, especially preferably 1:5 to 1:9.

The disperse dyes are usually used in an amount of 0.0001 to 0.1% by weight, preferably 0.0002 to 0.03% by weight, based on the weight of the treated fibre materials.

The washing procedure is usually done in washing machines.

There are various types of washing machines, for example:
top-loader-washing machines with a vertical rotating axis; these machines, which have usually a capacity of about 45 to 83 litres, are used for washing processes at temperatures of 10-50° C. and washing cycles of about 10-60 minutes. Such types of washing machines are often used in the USA;
front-loader-washing machines with a horizontal rotating axis; these machines, which have usually a capacity of about 8 to 15 litres, are used for washing processes at temperatures of 30-95° C. and washing cycles of about 10-60 minutes. Such types of washing machines are often used in Europe;
top-loader-washing machines with a vertical rotating axis; these machines, which have usually a capacity of about 26 to 52 litres, are used for washing processes at temperatures of 5-25° C. and washing cycles of about 8-15 minutes. Such types of washing machines are often used in Japan.

Hand washing is usually carried out at temperatures of 10 to 50° C., especially 25 to 40° C. The liquor ratio (fabric to water) is usually 1 to 10. The amount of detergent used for hand washing is, as a rule, 0.1 to 10% by weight, based on the weight of the fabric to be treated. The washing time is preferably 5 to 60 minutes. If desired, a pre-soaking step can be carried out, wherein, before hand washing, the fibre material is left for 0.2-24 hours in a solution or suspension of the detergent without agitation.

The detergents may be in solid, liquid, gel-like or paste-like form. The detergents may also be in the form of powders or (super-)compact powders or granules, in the form of single- or multi-layer tablets (tabs), in the form of washing agent bars, washing agent blocks, washing agent sheets, washing agent pastes or washing agent gels, or in the form of powders, pastes, gels or liquids used in capsules or in pouches (sachets).

For example, the detergents comprise:

| | |
|---|---|
| I) from 5 to 70 wt-% A) | of at least one anionic surfactant and/or B) |
| | at least one non-ionic surfactant, based on |
| | the total weight of the detergent, |
| II) from 0 to 60 wt-% C) | especially from 5 to 60 wt-% of at least one |
| | builder substance, based on the total weight |
| | of the detergent, |
| III) from 0 to 30 wt-% D) | of at least one peroxide and, optionally, at |
| | least one activator and/or at least one |
| | catalyst, based on the total weight of the |
| | detergent. |

It is preferred that the detergents also contain the disperse dyes, for example an amount of 0.0001 to 1.0 wt-% of disperse dyes, based on the total weight of the detergent. Preferred is an amount of 0.005 to 1.0 wt-% of disperse dyes.

It is to be understood that the detergents may also comprise further ingredients, like further additives or water.

The anionic surfactant A) can be, for example, a sulfate, sulfonate or carboxylate surfactant or a mixture thereof. Preferred sulfates are those having from 12 to 22 carbon atoms in the alkyl radical, optionally in combination with alkyl ethoxysulfates in which the alkyl radical has from 10 to 20 carbon atoms.

Preferred sulfonates are e.g. alkylbenzenesulfonates having from 9 to 15 carbon atoms in the alkyl radical. The cation in the case of anionic surfactants is preferably an alkali metal cation, especially sodium.

The anionic surfactant component may be, e.g., an alkylbenzenesulfonate, an alkylsulfate, an alkylethersulfate, an olefinsulfonate, an alkanesulfonate, a fatty acid salt, an alkyl or alkenyl ether carboxylate or an α-sulfofatty acid salt or an ester thereof. Preferred are alkylbenzenesulfonates having 10 to 20 carbon atoms in the alkyl group, alkylsulfates having 8 to 18 carbon atoms, alkylethersulfates having 8 to 22 carbon atoms, and fatty acid salts being derived from palm oil or tallow and having 8 to 22 carbon atoms. The average molar number of ethylene oxide added in the alkylethersulfate is preferably 1 to 22, preferably 1 to 10. The salts are preferably derived from an alkaline metal like sodium and potassium, especially sodium. Highly preferred carboxylates are alkali metal sarcosinates of formula R₁₀₉—CO(R₁₁₀)CH₂COOM₁ in which R₁₀₉ is alkyl or alkenyl having 8-20 carbon atoms in the alkyl or alkenyl radical, R₁₁₀ is C₁-C₄ alkyl and M₁ is an alkali metal, especially sodium.

Preferred as anionic surfactants are sulfonates, like olefinsulfonates, alkanesulfonates or especially alkylbenzenesulfonates having 10 to 20 carbon atoms in the alkyl group, especially C₁₀-C₁₆alkylbenzenesulfonates and more preferably C₁₁-C₁₄alkylbenzenesulfonates. Preferably the alkyl group of the alkylbenzenesulfonate is linear. Especially preferred are the sodium or potassium alkylbenzenesulfonates.

The nonionic surfactant component may be, e.g., primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide). Highly preferred are the above alcohol ethoxylates.

The total amount of anionic surfactant and nonionic surfactant is preferably 5-50 wt-%, preferably 5-40 wt-% and more preferably 5-30 wt-%. As to these surfactants it is preferred that the lower limit is 10 wt-%.

The non-ionic surfactant B) can be, for example, a condensation product of from 3 to 8 mol of ethylene oxide with 1 mol of a primary alcohol having from 9 to 15 carbon atoms.

The detergents preferably contain a sulfonate as anionic surfactant, especially an alkylbenzenesulfonate, in combination with a nonionic surfactant, especially an ethoxylated alcohol as given above. More preferably, the detergents contain in addition sodium chloride, especially in an amount of at least 0.1% by weight, based on the weight of the detergent.

As builder substance C) there come into consideration, for example, alkali metal phosphates, especially tripolyphosphates, carbonates or hydrogen carbonates, especially their sodium salts, silicates, aluminosilicates, polycarboxylates, polycarboxylic acids, organic phosphonates, aminoalkylenepoly(alkylenephosphonates) or mixtures of those compounds.

Especially suitable silicates are sodium salts of crystalline layered silicates of the formula NaHSiₜO₂ₜ₊₁.pH₂O or Na₂SiₜO₂ₜ₊₁.pH₂O wherein t is a number from 1.9 to 4 and p is a number from 0 to 20.

Among the aluminosilicates, preference is given to those commercially available under the names zeolithe A, B, X and HS, and also to mixtures comprising two or more of those components. Zeolithe A is preferred.

Among the polycarboxylates, preference is given to polyhydroxycarboxylates, especially citrates, and acrylates and also copolymers thereof with maleic anhydride. Preferred polycarboxylic acids are nitrilotriacetic acid, ethylenediaminetetraacetic acid and ethylenediamine disuccinate either in racemic form or in the enantiomerically pure (S,S) form.

Phosphonates or aminoalkylenepoly(alkylenephosphonates) that are especially suitable are alkali metal salts of 1-hydroxyethane-1,1-diphosphonic acid, nitrilotris(methylenephosphonic acid), ethylenediaminetetramethylenephosphonic acid, hexamethylenediamin N,N,N′,N′ tetrakis methanphosphonic acid and diethylenetriaminepentamethylenephosphonic acid, as well as the salts therefrom. Also preferred polyphosphonates have the following formula

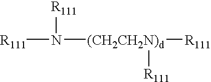

wherein
R₁₁₁ is CH₂PO₃H₂ or a water soluble salt thereof and
d is an integer of the value 0, 1 or 2.

Especially preferred are the polyphosphonates wherein d is an integer of the value of 1.

Suitable peroxide components include, for example, the organic and inorganic peroxides (like sodium peroxides) known in the literature and available commercially that bleach textile materials at conventional washing temperatures, for example at from 5 to 95° C.

The amount of the peroxide or the peroxide-forming substance is preferably 0.5-30% by weight, more preferably 1-20% by weight and especially preferably 1-15% by weight.

As the peroxide component D) there comes into consideration every compound which is capable of yielding hydrogen peroxide in aqueous solutions, for example, the organic and inorganic peroxides known in the literature and available commercially that bleach textile materials at conventional washing temperatures, for example at from 10 to 95° C.

The organic peroxides are, for example, mono- or poly-peroxides, urea peroxides, a combination of a C₁-C₄alkanol oxidase and C₁-C₄alkanol (such as methanol oxidase and ethanol as described in WO95/07972), alkylhydroxy peroxides, such as cumene

hydroperoxide and t-butyl hydroperoxide, organic mono peracids of formula

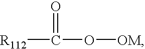

wherein
M signifies hydrogen or a cation,
R₁₁₂ signifies unsubstituted C₁-C₁₈alkyl; substituted C₁-C₁₈alkyl; unsubstituted aryl; substituted aryl; —(C₁-C₆alkylene)-aryl, wherein the alkylene and/or the alkyl group may be substituted; and phthalimidoC₁-C₈alkylene, wherein the phthalimido and/or the alkylene group may be substituted. Preferred mono organic peroxy acids and their salts are those of formula

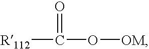

wherein
M signifies hydrogen or an alkali metal, and
R′₁₁₁₂ signifies unsubstituted C₁-C₄alkyl; phenyl; —C₁-C₂alkylene-phenyl or phthalimidoC₁-C₈alkylene.

Especially preferred is CH₃COOOH and its alkali salts.

Especially preferred is also ε-phthalimido peroxy hexanoic acid and its alkali salts.

Instead of the peroxy acid it is also possible to use organic peroxy acid precursors and H₂O₂. Such precursors are the corresponding carboxyacid or the corresponding carboxyanhydrid or the corresponding carbonylchlorid, or amides, or esters, which can form the peroxy acids on perhydrolysis. Such reactions are commonly known.

Peroxy acids may also be generated from precursors such as bleach activators, that is to say compounds that, under perhydrolysis conditions, yield unsubstituted or substituted perbenzo- and/or peroxo-carboxylic acids having from 1 to 10 carbon atoms, especially from 2 to 4 carbon atoms. Suitable bleach activators include the customary bleach activators, mentioned at the beginning, that carry O- and/or N-acyl groups having the indicated number of carbon atoms and/or unsubstituted or substituted benzoyl groups. Preference is given to polyacylated alkylenediamines, especially tetraacetylethylenediamine (TAED), acylated glycolurils, especially tetraacetylglycoluril (TAGU), N,N-diacetyl-N,N-dimethylurea (DDU), acylated triazine derivatives, especially 1,5-diacetyl-2,4-dioxohexahydro-1,3,5-triazine (DADHT), compounds of formula:

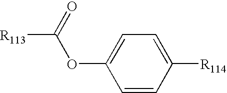

wherein R₁₁₃ is a sulfonate group, a carboxylic acid group or a carboxylate group, and wherein R₁₁₄ is linear or branched (C₇-C₁₅)alkyl, especially activators known under the names SNOBS, SLOBS and DOBA, acylated polyhydric alcohols, especially triacetin, ethylene glycol diacetate and 2,5-diacetoxy-2,5-dihydrofuran, and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

Also suitable are diperoxyacids, for example, 1,12-diperoxydodecanedioic acid (DPDA), 1,9-diperoxyazelaic acid, diperoxybrassilic acid; diperoxysebasic acid, diperoxyisophthalic acid, 2-decyldiperoxybutane-1,4-diotic acid and 4,4′-sulphonylbisperoxybenzoic acid.

Preferably, however, inorganic peroxides are used, for example persulfates, perborates, percarbonates and/or persilicates.

Examples of suitable inorganic peroxides are sodium tetrahydrate or sodium perborated monohydrate, inorganic peroxyacid compounds, such as for example potassium monopersulphate (MPS). If organic or inorganic peroxyacids are used as the peroxygen compound, the amount thereof will normally be within the range of about 2-10 wt-%, preferably from 4-8 wt-%.

All of these peroxy compounds may be utilized alone or in conjunction with a peroxyacid bleach precursor and/or an organic bleach catalyst not containing a transition metal. Generally, the composition can be suitably formulated to contain from 2 to 35 wt-%, preferably from 5 to 25 wt-%, of the peroxy bleaching agent.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393. Preferred one are those disclosed in WO 01/05925), especially preferred the 1:1 Mn(III) complexes.

Another useful class of peroxyacid bleach precursors is that of the cationic i.e. quaternary ammonium substituted peroxyacid precursors as disclosed in U.S. Pat. Nos. 4,751,015 and 4,397,757, in EP-A-0284292 and EP-A-331,229. Examples of peroxyacid bleach precursors of this class are: 2-(N,N,N-trimethyl ammonium) ethyl sodium-4-sulphonphenyl carbonate chloride-(SPCC), N-octyl,N,N-dimethyl-N10-carbophenoxy decyl ammonium chloride-(ODC), 3-(N,N,N-trimethyl ammonium) propyl sodium-4-sulphophenyl carboxylate and N,N,N-trimethyl ammonium toluoyloxy benzene sulphonate.

Any one of these peroxyacid bleach precursors can be used in the present invention, though some may be more preferred than others.

Of the above classes of bleach precursors, the preferred classes are the esters, including acyl phenol sulphonates and acyl alkyl phenol sulphonates; the acyl-amides; and the quaternary ammonium substituted peroxyacid precursors.

Examples of said preferred peroxyacid bleach precursors or activators are sodium-4-benzoyloxy benzene sulphonate (SBOBS); N,N,N′N′-tetraacetyl ethylene diamine (TAED); sodium-1-methyl-2-benzoyloxy benzene-4-sulphonate; sodium-4-methyl-3-benzoloxy benzoate; SPCC; trimethyl ammonium toluoyloxy-benzene sulphonate; sodium nonanoyloxybenzene sulphonate (SNOBS); sodium 3,5,5-trimethyl hexanoyl-oxybenzene sulphonate (STHOBS).

The precursors may be used in an amount of up to 12%, preferably from 2-10% by weight, of the composition.

It will be understood that mixtures of inorganic and/or organic peroxides can also be used. The peroxides may be in a variety of crystalline forms and have different water contents, and they may also be used together with other inorganic or organic compounds in order to improve their storage stability.

The peroxides are added to the detergent preferably by mixing the components, for example using a screw metering system and/or a fluidised bed mixer.

The detergents may also comprise one or more optical brighteners, for example from the class bis-triazinylamino-stilbenedisulfonic acid, bis-triazolyl-stilbenedisulfonic acid, bis-styryl-biphenyl or bis-benzofuranylbiphenyl, a bis-benzoxalyl derivative, bis-benzimidazolyl derivative or coumarin derivative or a pyrazoline derivative.

The detergents used will usually contain one or more auxiliaries such as soil suspending agents, for example sodium carboxymethylcellulose; salts for adjusting the pH, for example alkali or alkaline earth metal silicates; foam regulators, for example soap; salts for adjusting the spray drying and granulating properties, for example sodium sulphate; perfumes; and also, if appropriate, antistatic and softening agents; such as smectite clays; photobleaching agents; pigments; and/or shading agents. These constituents should, of course, be stable to any bleaching system employed. Such auxiliaries can be present in an amount of, for example, 0.1 to 20 wt-%, preferably 0.5 to 10 wt-%, especially 0.5 to 5 wt-%, based on the total weight of the detergent.

Furthermore, the detergent can optionally contain enzymes. Enzymes can be added to detergents for stain removal. The enzymes usually improve the performance on stains that are either protein- or starch-based, such as those caused by blood, milk, grass or fruit juices. Preferred enzymes are cellulases, proteases, amylases and lipases. Preferred enzymes are cellulases and proteases, especially proteases. Cellulases are enzymes which act on cellulose and its derivatives and hydrolyze them into glucose, cellobiose, cellooligosaccharide. Cellulases remove dirt and have the effect of mitigating the roughness to the touch. Examples of enzymes to be used include, but are by no means limited to, the following:

proteases as given in U.S. Pat. No. 6,242,405, column 14, lines 21 to 32;
lipases as given in U.S. Pat. No. 6,242,405, column 14, lines 33 to 46 and as given in WO-A-0060063;
amylases as given in U.S. Pat. No. 6,242,405, column 14, lines 47 to 56; and
cellulases as given in U.S. Pat. No. 6,242,405, column 14, lines 57 to 64.

Commercially available detergent proteases, such as Alcalase®, Esperase®, Everlase®, Savinase®, Kannase® and Durazym®, are sold e.g. by NOVOZYMES A/S.

Commercially available detergent amylases, such as Termamyl®, Duramyl®, Stainzyme®, Natalase®, Ban® and Fungamyl®, are sold e.g. by NOVOZYMES A/S.

Commercially available detergent ellulases, such as Celluzyme®, Carezyme® and Endolase®, are sold e.g. by NOVOZYMES A/S.

Commercially available detergent lipases, such as Lipolase®, Lipolase Ultra® and Lipoprime®, are sold e.g. by NOVOZYMES A/S.

Suitable mannanases, such as Mannanaway®, are sold by NOVOZYMES A/S.

The enzymes can optionally be present in the detergent. When used, the enzymes are usually present in an amount of 0.01-5 wt-%, preferably 0.05-5 wt-% and more preferably 0.1-4 wt-%, based on the total weight of the detergent.

Further preferred additives to the detergents are dye fixing agents and/or polymers which, during the washing of textiles, prevent staining caused by dyes in the washing liquor that have been released from the textiles under the washing conditions. Such polymers are preferably polyvinylpyrrolidones, polyvinylimidazole or polyvinylpyridine-N-oxides which may have been modified by the incorporation of anionic or cationic substituents, especially those having a molecular weight in the range of from 5000 to 60000, more especially from 5000 to 50000. Such polymers are usually used in an amount of from 0.01 to 5 wt-%, preferably 0.05 to 5 wt-%, especially 0.1 to 2 wt-%, based on the total weight of the detergent. Preferred polymers are those given in WO-A-02/02865 (see especially page 1, last paragraph and page 2, first paragraph).

The detergent may also be formulated as an aqueous liquid comprising 5-50, preferably 10-35 wt-% of water or as a non-aqueous liquid detergent, containing not more than 5, preferably 0-1 wt-% of water. Non-aqueous liquid detergent compositions can contain other solvents as carriers. Low molecular weight primary or secondary alcohols exemplified by methanol, ethanol, propanol, and isopropanol are suitable. Monohydric alcohols are preferred for solubilizing surfactant, but polyols such as those containing from 2 to about 6 carbon atoms and from 2 to about 6 hydroxy groups (e.g., 1,3-propanediol, ethylene glycol, glycerine, and 1,2-propanediol) can also be used. The detergents may contain from 5 wt-% to 90 wt-%, typically 10 wt-% to 50 wt-% of such carriers. The detergents can also be present as the so-called “unit liquid dose” form.

Highly preferred are the following detergent compositions:

a) Granular detergent compositions comprising 1-25 wt-% alkylbenzenesulfonates having from 9 to 15 carbon, 1-15 wt-% Na₂CO₃, 1-15 wt-% alkalimetalphosphate, 1-15 wt-% sodium salts of silicates, 5-35 wt-% sodium sulfate and 0-1 wt-% protease; especially granular detergent compositions comprising 10-25 wt-% alkylbenzenesulfonates having from 9 to 15 carbon, 8-15 wt-% Na₂CO₃, 8-15 wt-% alkalimetalphosphate, 5-15 wt-% sodium salts of silicates, 20-35 wt-% sodium sulfate and 0-1 wt-% protease.
b) Granular detergent compositions comprising 1-15 wt-% alkylbenzenesulfonates, 0-6 wt-% alkylsulphates having 7-19 carbon, 1-8 wt-% non-ionic surfactants based on alkylethylenoxides, 0-5 wt-% of a polymer based on acrylic acid as one of the repeating units, 1-15 wt-% bleaching agent such as sodiumpercarbonate, 1-6 wt-% bleach activator such as TAED, 0-2 wt-% enzymes such as protease and amlyse and 0-0.5 wt-% of a fluorescent whitening agent;
especially granular detergent compositions comprising 5-15 wt-% alkylbenzenesulfonates, 0-6 wt-% alkylsulphates having 7-19 carbon, 2-8 wt-% non-ionic surfactants based on alkylethylenoxides, 0-5 wt-% of a polymer based on acrylic acid as one of the repeating units, 5-15 wt-% bleaching agent such as sodiumpercarbonate, 2-6 wt-% bleach activator such as TAED, 0-2 wt % enzymes such as protease and amlyse and 0-0.5 wt-% of a fluorescent whitening agent.
c) A detergent bar comprising 1-30 wt-% alkylbenzenesulfonates, 1-20 wt-% alkalimetalphosphates, 5-40 wt-% Na₂CO₃ and 0-2 wt-% carboxymethylcellulose; especially a detergent bar comprising 5-20 wt-% alkylbenzenesulfonates, 5-15 wt-% alkalimetalphosphates, 15-30 wt-% Na₂CO₃ and 0.5-2 wt-% carboxymethylcellulose

It is to be understood that the above detergents can contain further ingredients, like additives or water. Wt-% are based on the total weight of the detergent.

The disperse dyes can also be applied in a soaking process, where the fibre material is left for 0.5-24 hours in a solution or suspension of the detergent (or a bleaching laundry additive) without agitation. Soaking can take place for example in a bucket or in a washing machine. Usually the fibre materials are washed and/or rinsed after the soaking process.

According to a further embodiment of the present invention the fibre materials are treated with at least one disperse dye in the rinse step of a laundry process. In this process it is also possible to add a fabric softener. The fabric softener and the disperse dyes may be added separately; however, it is preferred that the disperse dyes are part of the fabric softener.

Fabric softening compounds, especially hydrocarbon fabric softening compounds, suitable for use herein are selected from the following classes of compounds:

(i) Cationic quaternary ammonium salts. The counter ion of such cationic quaternary ammonium salts may be a halide, such as chloride or bromide, methyl sulphate, or other ions well known in the literature. Preferably the counter ion is methyl sulfate or any alkyl sulfate or any halide.

Examples of cationic quaternary ammonium salts include but are not limited to

(1) Acyclic quaternary ammonium salts having at least two C₈ to C₃₀, preferably C₁₂ to C₂₂ alkyl or alkenyl chains, such as: ditallowedimethyl ammonium methylsulfate, di(hydrogenated tallow)dimethyl ammonium methylsulfate, di(hydrogenated tallow)dimethyl ammonium methylchloride, distearyldimethyl ammonium methyl-sulfate, dicocodimethyl ammonium methylsulfate and the like. It is especially preferred if the fabric softening compound is a water insoluble quaternary ammonium material which comprises a compound having two C₁₂ to C₁₈ alkyl or alkenyl groups connected to the molecule via at least one ester link. It is more preferred if the quaternary ammonium material has two ester links present. An especially preferred ester-linked quaternary ammonium material for use in the invention can be represented by the formula:

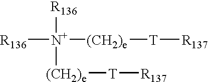

wherein each R₁₃₆ group is independently selected from C₁ to C₄ alkyl, hydroxyalkyl or C₂ to C₄ alkenyl groups; T is either —O—C(O)— or —C(O)—O—, and wherein each R₁₃₇ group is independently selected from C₈ to C₂₈ alkyl or alkenyl groups; and e is an integer from 0 to 5.

A second preferred type of quaternary ammonium material can be represented by the formula:

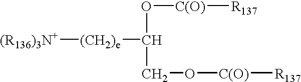

wherein R₁₃₆, e and R₁₃₇ are as defined above.
(2) Cyclic quaternary ammonium salts of the imidazolinium type such as di(hydrogenated tallow)dimethyl imidazolinium methylsulfate, 1-ethylene-bis(2-tallow-1-methyl) imidazolinium methylsulfate and the like;
(3) Diamido quaternary ammonium salts such as: methyl-bis(hydrogenated tallow amidoethyl)-2-hydroxethyl ammonium methyl sulfate, methyl bi(tallowamidoethyl)-2-hydroxypropyl ammonium methylsulfate and the like;
(4) Biodegradable quaternary ammonium salts such as N,N-di(tallowoyl-oxy-ethyl)-N,N-dimethyl ammonium methyl sulfate and N,N-di(tallowoyl-oxy-propyl)-N,N-dimethyl ammonium methyl sulfate. Biodegradable quaternary ammonium salts are described, for example, in U.S. Pat. Nos. 4,137,180, 4,767,547 and 4,789,491 incorporated by reference herein.

Preferred biodegradable quaternary ammonium salts include the biodegradable cationic diester compounds as described in U.S. Pat. No. 4,137,180, herein incorporated by reference.

(ii) Tertiary fatty amines having at least one and preferably two C₈ to C₃₀, preferably C₁₂ to C₂₂ alkyl chains. Examples include hardened tallow-di-methylamine and cyclic amines such as 1-(hydrogenated tallow)amidoethyl-2-(hydrogenated tallow) imidazoline. Cyclic amines, which may be employed for the compositions herein, are described in U.S. Pat. No. 4,806,255 incorporated by reference herein.
(iii) Carboxylic acids having 8 to 30 carbons atoms and one carboxylic group per molecule. The alkyl portion has 8 to 30, preferably 12 to 22 carbon atoms. The alkyl portion may be linear or branched, saturated or unsaturated, with linear saturated alkyl preferred. Stearic acid is a preferred fatty acid for use in the composition herein. Examples of these carboxylic acids are commercial grades of stearic acid and palmitic acid, and mixtures thereof, which may contain small amounts of other acids.
(iv) Esters of polyhydric alcohols such as sorbitan esters or glycerol stearate. Sorbitan esters are the condensation products of sorbitol or iso-sorbitol with fatty acids such as stearic acid. Preferred sorbitan esters are monoalkyl. A common example of sorbitan ester is SPAN® 60 (ICI) which is a mixture of sorbitan and isosorbide stearates.
(v) Fatty alcohols, ethoxylated fatty alcohols, alkylphenols, ethoxylated alkylphenols, ethoxylated fatty amines, ethoxylated monoglycerides and ethoxylated diglycerides.
(vi) Mineral oils, and polyols such as polyethylene glycol.

These softening compounds are more definitively described in U.S. Pat. No. 4,134,838 the disclosure of which is incorporated by reference herein. Preferred fabric softening compounds for use herein are acyclic quaternary ammonium salts. Mixtures of the above mentioned fabric softening compounds may also be used.

The fabric softeners preferably comprise about 0.001-2.0 wt-%, especially 0.015-1.5 wt-% of disperse dyes, based on the total weight of the fabric softener.

The fabric softeners preferably comprise about 0.1 to about 95 wt-% of fabric softening compounds, based on the total weight of the fabric softener. Preferred is an amount of 0.5 to 50 wt-%, especially an amount of 2 to 50 wt-% and most preferably an amount of 2 to 30 wt-%.

The fabric softeners may also comprise additives which are customary for standard commercial fabric softeners, for example alcohols, such as ethanol, n-propanol, i-propanol, polyhydric alcohols, for example glycerol and propylene glycol; amphoteric and nonionic surfactants, for example carboxyl derivatives of imidazole, oxyethylated fatty alcohols, hydrogenated and ethoxylated castor oil, alkyl polyglycosides, for example decyl polyglucose and dodecylpolyglucose, fatty alcohols, fatty acid esters, fatty acids, ethoxylated fatty acid glycerides or fatty acid partial glycerides; also inorganic or organic salts, for example water-soluble potassium, sodium or magnesium salts, non-aqueous solvents, pH buffers, perfumes, dyes, hydrotropic agents, antifoams, anti redeposition agents, enzymes, optical brighteners, antishrink agents, stain removers, germicides, fungicides, dye fixing agents or dye transfer inhibitors (as described in WO-A-02/02865), antioxidants, corrosion inhibitors, wrinkle recovery or wet soiling reduction agent, such as polyorganosiloxanes. The latter two additives are described in WO0125385.

Such additives are preferably used in an amount of 0 to 30 wt-%, based on the total weight of the fabric softener. Preferred is an amount of 0 to 20 wt-%, especially an amount of 0 to 10 wt-% and most preferably an amount of 0 to 5 wt-%, based on the total weight of the fabric softener.

The fabric softeners are preferably in liquid aqueous form. The fabric softeners preferably contain a water content of 25 to 90 wt-%, based on the total weight of the composition. More preferably the water content is 50 to 90 wt-%, especially 60 to 90 wt-%.

The fabric softeners preferably have a pH value from 2.0 to 9.0, especially 2.0 to 5.0.

These fabric softener compositions are traditionally prepared as dispersions containing for example up to 30 wt-% of active material in water. They usually have a turbid appearance. However, alternative formulations usually containing actives at levels of 5 to 40 wt-% along with solvents can be prepared as microemulsions, which have a clear appearance (as to the solvents and the formulations see for example U.S. Pat. No. 5,543,067 und WO-A-98/17757).

Furthermore, the present invention is directed to the use of disperse dyes for improving the whiteness of fibre materials selected from the group consisting of polyester, polyamide, polyacrylonitrile, wool and silk, comprising treating the fibre materials with at least one disperse dye in a laundry process. As to this embodiment the definitions and preferences given before apply.

Another subject of the present invention are detergent compositions as well as fabric softening compositions for improving the whiteness of fibre materials selected from the group consisting of polyester, polyamide, polyacrylonitrile, wool and silk, comprising at least one disperse dye. As to these compositions the definitions and preferences given before apply.

The following Examples serve to illustrate the invention but do not limit the invention thereto. Parts and percentages relate to weight, unless otherwise indicated. Temperatures are in degrees Celsius, unless otherwise indicated.

### EXAMPLE 1

100 parts of white polyester fabric are washed for 15 min at 30° C. in a liquor containing 4 g/l detergent ECE 77 in 1000 parts of tap water.

The washed fabric is rinsed with tap water, spin dried and finally dried at 60° C.

The experiment is repeated exactly as given above, but this time 0.0075 parts of the disperse dye of formula

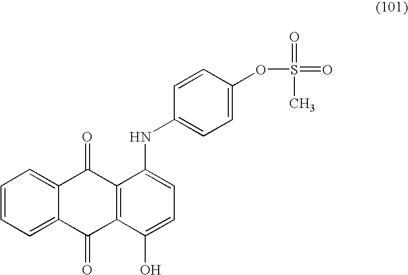

are added to the wash liquor.

The whiteness grade of the polyester fabrics treated as given above is measured by the Ganz/Griesser-method. The results are shown in the following table.

| | Whiteness grade |
|---|---|
| | according to Ganz |
| White polyester fabric | 201 |
| White polyester fabric, washed with ECE 77 | 201 |
| White polyester fabric, washed with ECE 77 | 230 |
| and 0.0075 parts of the disperse dye of | |
| formula (101) | |

The polyester fabric treated without use of a disperse dye shows the same whiteness as the untreated polyester fabric, whereas with treatment of the disperse dye a distinct improvement of the whiteness can be observed.

Similar results can be obtained by replacing the above disperse dye of formula (101) by an equimolar amount of the disperse dye of formula

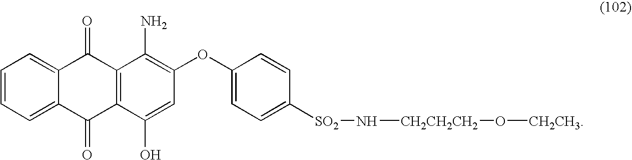

### EXAMPLE 2

The procedure of Example 1 is repeated using a different polyester fabric without optical brightener.

The whiteness grade of the polyester fabrics treated as given above is measured by the Ganz/Griesser-method. The results are shown in Table 2 and Table 3

TABLE 2

| | WGanz |
|---|---|
| Polyester fabric initial | 71 |
| Polyester fabric, washed with ECE 77 without dye | 68 |
| 0.0075% (103) | 92 |
| 0.0075% (104) | 79 |
| 0.0075% (105) | 96 |
| 0.0075% (106) | 84 |
| 0.0075% (107) | 80 |

TABLE 3

| | WGanz |
|---|---|
| Polyester fabric initial | 72 |
| 0.0075% (103) | 93 |
| 0.005% (108) | 114 |
| 0.005% (109) | 118 |
| 0.005% (110) | 99 |
| 0.005% (111) | 83 |

All disperse dyes used are items of commerce:

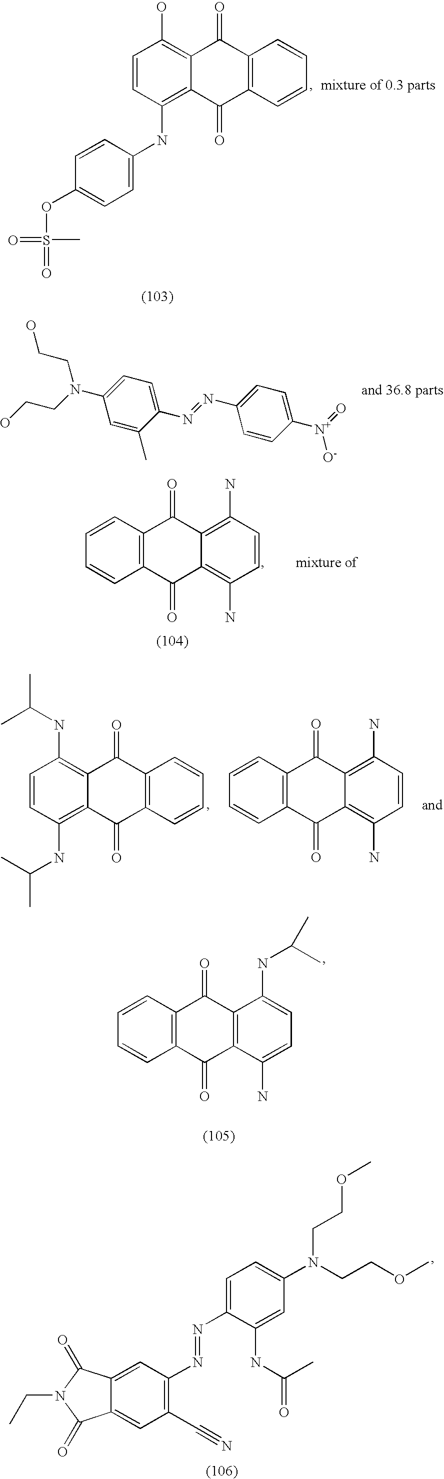

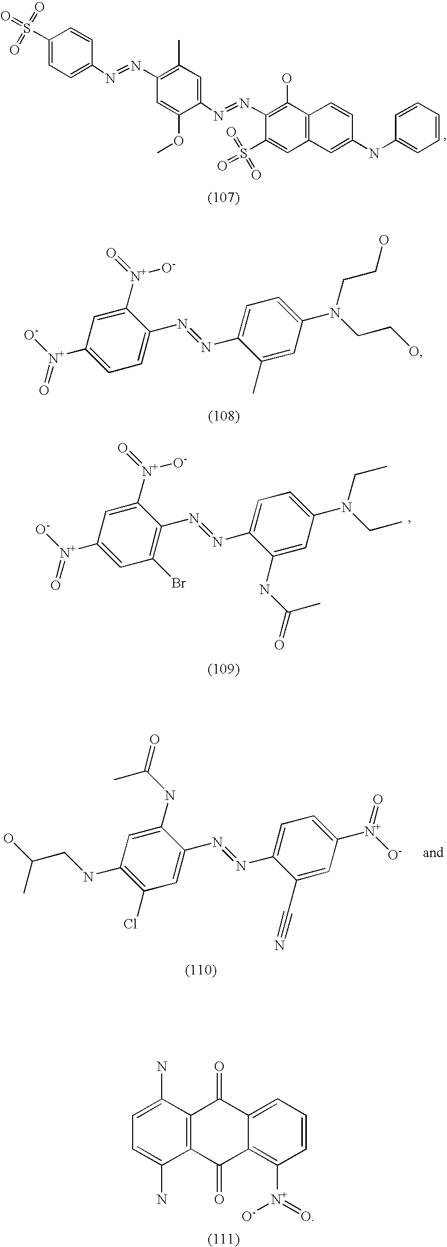

1. A process for improving the whiteness of fibre materials selected from the group consisting of polyester, polyamide, polyacrylonitrile, wool and silk, comprising treating the fibre materials with at least one disperse dye in a laundry process.

2. A process according to claim 1, wherein the fibre materials are treated with at least one disperse dye together with a detergent in the washing step of a laundering process.

3. A process according to claim 1, wherein the fibre materials are treated with at least one disperse dye in the rinse step of a laundering process.

4. A process according to claim 3, wherein the fibre materials are treated with at least one disperse dye together with a fabric softener in the rinse step of a laundering process.

5. A process according to claim 1, wherein the fibre material is polyester, polyamide or polyacrylonitrile.

6. A process according to claim 1, wherein the fibre material is polyester or polyamide.

7. A process according to claim 1, wherein the fibre material is polyester or a blend comprising polyester.

8. A process according to claim 1, wherein the fibre material is polyester, or a polyester/cotton or polyester/polyamide blend.

9. A process according to claim 1, wherein at least one disperse dye of the following formulae is used: 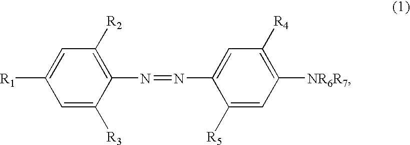
in which
R₁ is halogen, nitro or cyano,
R₂ is hydrogen, halogen, nitro or cyano,
R₃ is hydrogen, halogen or cyano,
R₄ is hydrogen, halogen, C₁-C₄alkyl or C₁-C₄alkoxy,
R₅ is hydrogen, halogen or C₂-C₄alkanoylamino, and
R₆ and R₇ independently of one another are hydrogen, allyl, C₁-C₄alkyl which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy, 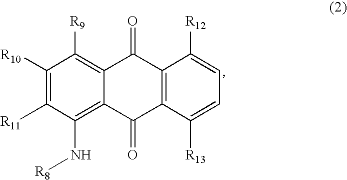
in which
R₈ is hydrogen, C₁-C₄alkyl, phenyl or phenylsulfonyl, the benzene ring in phenyl and phenylsulfonyl being unsubstituted or substituted by C₁-C₄alkyl, sulfo or C₁-C₄alkyl-sulfonyloxy,
R₉ is hydroxy, amino, N-mono- or N,N-di-C₁-C₄alkylamino, phenylamino, the benzene ring in phenyl being unsubstituted or substituted by halogen, C₁-C₄alkyl, C₁-C₄alkoxy,
C₂-C₄alkanoylamino, or C₁-C₈alkylaminosulfonyl which can be interrupted in the alkyl chain by —O—
R₁₀ is hydrogen, C₁-C₄alkoxy or cyano,
R₁₁ is hydrogen, C₁-C₄alkoxy, phenoxy or the radical —O—C₆H₅—SO₂—NH—(CH₂)₃—O—C₂H₅,
R₁₂ is hydrogen, hydroxy or nitro, and
R₁₃ is hydrogen, hydroxy or nitro, 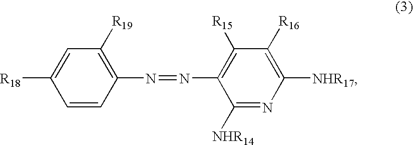
in which
R₁₄ is C₁-C₄alkyl which is unsubstituted or substituted by hydroxy,
R₁₅ is C₁-C₄alkyl,
R₁₆ is cyano,
R₁₇ is the radical of the formula —(CH₂)₃—O—(CH₂)₂—O—C₆H₅,
R₁₈ is halogen, nitro or cyano, and
R₁₉ is hydrogen, halogen, nitro or cyano, 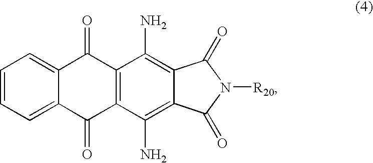
in which
R₂₀ is C₁-C₄alkyl, which is unsubstituted or substituted by hydroxy, C₁-C₄alkoxy, C₁-C₄-alkoxy-C₁-C₄alkoxy, C₂-C₄alkanoyloxy or C₁-C₄alkoxycarbonyl, 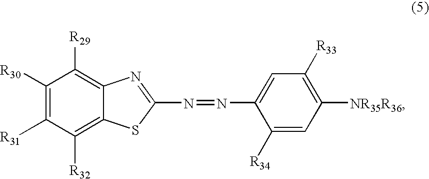
in which
R₂₉, R₃₀, R₃₁ and R₃₂ independently of one another are hydrogen or halogen,
R₃₃ is hydrogen, halogen, C₁-C₄alkyl or C₁-C₄alkoxy,
R₃₄ is hydrogen, halogen or C₂-C₄alkanoylamino, and
R₃₅ and R₃₆ independently of one another are hydrogen, C₁-C₄alkyl, which is unsubstituted or substituted by hydroxy, cyano, acetoxy or phenoxy, 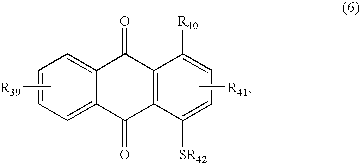
in which
R₃₉ is hydrogen or thiophenyl, which is unsubstituted or substituted in the phenyl by C₁-C₄-alkyl or C₁-C₄-alkoxy,
R₄₀ is hydrogen, hydroxy or amino,
R₄₁ is hydrogen, halogen, cyano or thiophenyl, which is unsubstituted or substituted in the phenyl by C₁-C₄alkyl or C₁-C₄-alkoxy, phenoxy or phenyl, and
R₄₂ is phenyl, which is unsubstituted or substituted by halogen, C₁-C₄alkyl or C₁-C₄-alkoxy, 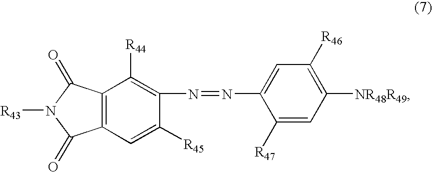
in which
R₄₃ is hydrogen or C₁-C₄alkyl,
R₄₄ and R₄₅ independently of one another are hydrogen, halogen, nitro or cyano,
R₄₆ is hydrogen, halogen, C₁-C₄alkyl or C₁-C₄alkoxy,
R₄₇ is hydrogen, halogen or C₂-C₄alkanoylamino, and
R₄₈ and R₄₉ independently of one another are hydrogen or C₁-C₄alkyl, which is unsubstituted or substituted by hydroxy, cyano, C₁-C₄alkoxy, C₁-C₄alkoxy-C₁-C₄alkoxy, C₂-C₄alkanoyloxy,
C₁-C₄alkoxycarbonyl, phenyl or phenoxy.

10. A process according to claim 1, wherein the disperse dyes are used in an amount of 0.0001 to 0.1% by weight, based on the weight of the treated fibre materials.

11. (canceled)

12. Detergent composition for improving the whiteness of fibre materials selected from the group consisting of polyester, polyamide, polyacrylonitrile, wool and silk, comprising at least one disperse dye.

13. Fabric softening composition for improving the whiteness of fibre materials selected from the group consisting of polyester, polyamide, polyacrylonitrile, wool and silk, comprising at least one disperse dye.
